(19) United States
(12) Patent Application Publication
(10) Pub. No.: US 2007/0251968 A1
(43) Pub. Date: Nov. 1, 2007

(54) MINI-STAPLER WITH ELASTIC BAND

(75) Inventor: Michael Parrish, Vernon Hills, IL (US)

Correspondence Address: MCNEES WALLACE & NURICK LLC, 100 PINE STREET, P.O. BOX 1166, HARRISBURG, PA, 17108-1166, US

(73) Assignee: ELMER'S PRODUCTS, INC., Columbus, OH (US)

(21) Appl. No.: 11/562,527

(22) Filed: Nov. 22, 2006

Related U.S. Application Data
(60) Provisional application No. 60/745,788, filed on Apr. 27, 2006.

(51) Int. Cl. B25C 5/06

(52) U.S. Cl. 227/120

(57) ABSTRACT

A miniature hand-held stapler is provided. This stapler includes a body for holding staples and providing a stapling mechanism, a lid attached to the body by hinge means, a base attached to the body and to the lid, wherein the base further includes a first portion and a second portion detachably or fixedly attached to the first portion, and wherein the second portion further includes a flexible or resilient band attached thereto or formed integrally therewith, and wherein the flexible or resilient band may be deployed over a portion of the lid to secure the lid and the body to the base when the stapler is being stored or transported.

### CROSS-REFERENCE TO RELATED APPLICATIONS

This patent application claims the benefit of U.S. Provisional Patent Application Ser. No. 60/745,788 filed on Apr. 27, 2006 and entitled “Mini-Stapler with Elastic Band,” the disclosure of which is incorporated by reference as if fully rewritten herein.

### BACKGROUND OF THE INVENTION

The present invention relates generally to staplers for home, office or school use, and more specifically to a miniaturized hand-held stapler that includes a flexible band of material used both to assist in securing the stapler in a closed position when not in use and to minimize the profile of the stapler when not in use.

Staplers are common items in many households, classrooms, and offices and are commercially available from various sources. Despite being common items, many staplers are not actually convenient devices because they not suitable for transport in a shirt or pant pocket or a purse, handbag, book bag, or the like. Staplers tend to be relatively heavy and somewhat unwieldy and may not be entirely safe for transport on one's person due to the possibility that the stapler may inadvertently open and/or unintentionally discharge one or more staples. Thus, there is an ongoing need for a relatively small, lightweight stapling device that is easily and safely transported on one's person.

### SUMMARY OF THE INVENTION

The following provides a summary of exemplary embodiments of a miniature stapler according to the present invention. This summary is not an extensive overview and is not intended to identify key or critical aspects or elements of the present invention or to delineate its scope.

In accordance with one aspect of the present invention, a device for dispensing staples is provided. This device includes a top portion, a bottom portion connected to the top portion, and a flexible band attached to or formed integrally with the bottom portion, wherein the flexible band may be deployed to secure or partially secure the top portion to the bottom portion.

In accordance with another aspect of the present invention, a hand-held stapler is provided. This stapler includes a body for holding staples and providing a stapling mechanism, a lid attached to the body, and a base attached to the body and to the lid, wherein the base further includes a first portion and a second portion detachably or fixedly attached to the first portion, wherein the second portion further includes a flexible band attached thereto or formed integrally therewith, and wherein the flexible band may be deployed over a portion of the lid to secure the lid and the body to the base and reduce the profile of the device.

In yet another aspect of this invention, a method for securing a stapler in a closed or partially closed position is provided. This method includes providing a stapler, wherein the stapler further includes: a body for holding staples, a lid attached to the body by hinge means, and a base attached to the body and to the lid, wherein the base further includes a first portion and a second portion, wherein the second portion further includes a flexible band attached thereto or formed integrally therewith, and deploying the flexible band over a front portion of the lid when the stapler is in the closed position, wherein deploying the flexible band exerts compressive force on the lid sufficient to hold the lid and the body near the base or against the base.

As described, the present invention provides a hand-held stapler, which may be miniaturized, that includes a flexible band of material that secures the top portion of the stapler to the bottom portion of the stapler for purposes of enhancing the portability of the stapler. Thus, one advantage of the stapler of the present invention is that it may be easily and safely carried in a pant pocket, coat pocket, purse or handbag. Additional features, aspects, and advantages of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a bottom perspective view of an exemplary embodiment of the miniature hand-held stapler of the present invention.

FIG. 2 is a top perspective view of the stapler illustrated in FIG. 1

FIG. 3 is a side view of the stapler illustrated in FIG. 1.

### DETAILED DESCRIPTION OF THE INVENTION

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention provides a miniaturized hand-held stapler that may be easily transported in a shirt or pant pocket, or a purse, handbag, book bag, or the like. In the exemplary embodiment shown in the Figures, this stapler includes a body for holding staples; a contoured lid attached to the body; and a base attached to the body and to the lid. The base further includes a first substantially rigid portion and a second more flexible portion detachably or fixedly attached to the first portion. The second portion further includes an elastic or resilient band attached thereto or formed integrally therewith or otherwise attached to the base. The elastic band may be deployed over a front portion of the contoured lid or elsewhere on the lid to help secure the lid and the body to the base when the stapler is not being used.

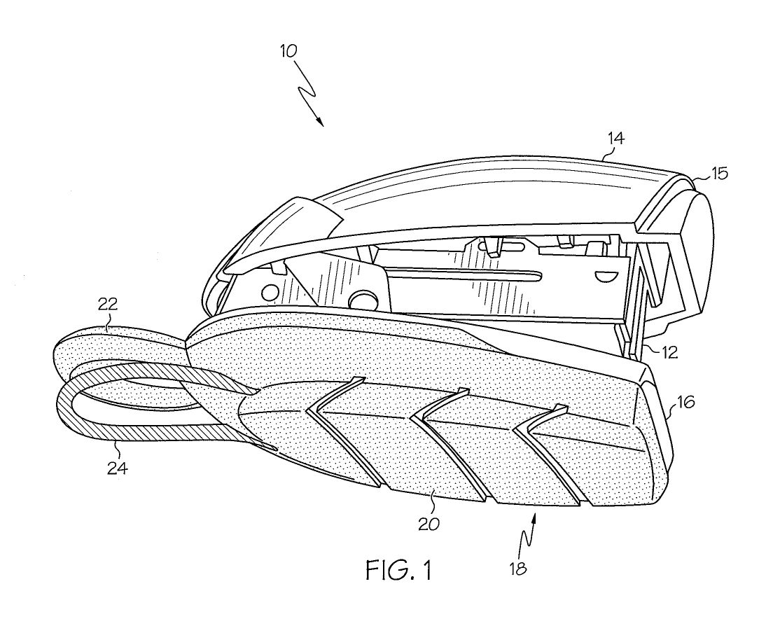

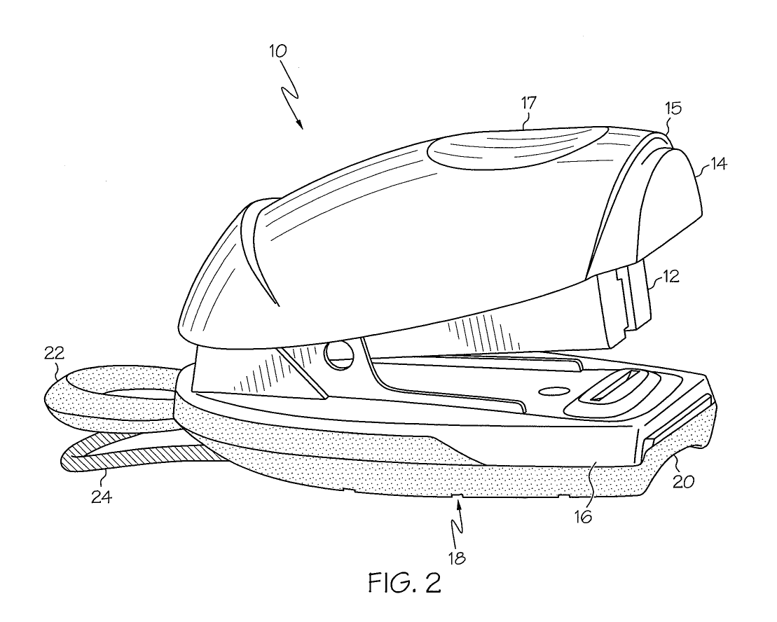

With reference now to the Figures, FIGS. 1-3 illustrate an embodiment of stapler 10 that includes a body 12 for holding staples, a contoured lid 14 attached to the body by hinge means or by other means, and a base 16, which is also attached to the body by hinge means or by other means. Body 12, which is adapted to receive staples, includes a stapling mechanism. In the exemplary embodiment, this stapling mechanism includes a top portion that is attached to the underside of lid 14, a bottom portion that is attached to the top surface of base 16, and a middle portion that is hingeably attached to the middle portion. The top portion of body 12 further includes biasing means, which act against the middle portion when lid 14 is depressed. Additionally, a spring is attached both to the top portion and to a staple-driving member that rests within the middle portion for keeping staples in the proper position for ejection from stapler 10. Other internal configurations and other stapler mechanisms are compatible with this device. As best shown in FIG. 2, the top surface of lid 14 includes a depression 17 for receiving the thumb or finger of a user of stapler 10.

As shown in FIGS. 1-3, base 16 includes a first rigid portion and a second more flexible portion, which is detachably or fixedly attached to the first portion. In the exemplary embodiment, the second portion of base 16 further includes a non-slip material 18, which provides gripping means for preventing stapler 10 from sliding across a desktop or tabletop when stapler 10 is actuated on a solid surface. Non-slip material 18 is typically rubber, rubberized plastic, elastomer, or combinations thereof. A concave surface 20 is formed in or on non-slip material 18 and may be used as a secure grasping surface when stapler 10 is actuated with a single hand. A flexible loop 22 is formed on one edge of non-slip material 18 and may be used to attach stapler 10 to a key ring, carabineer, length of rope, or the like.

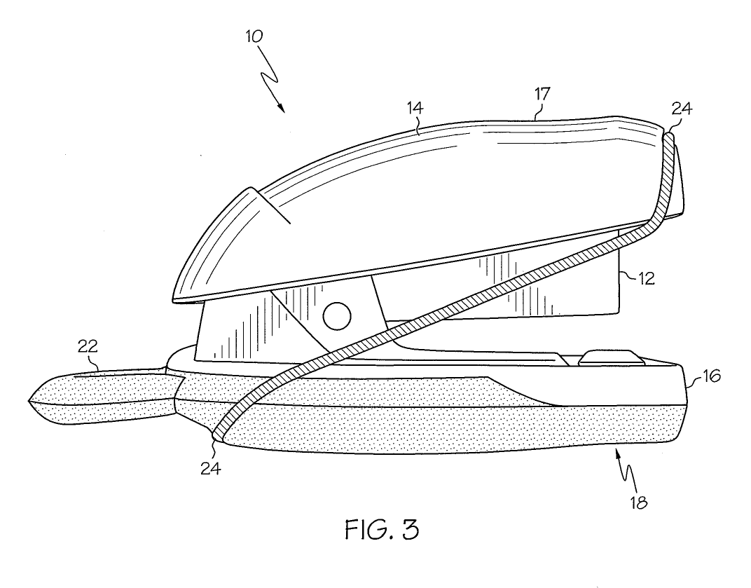

As also shown in FIGS. 1-3, band 24, which includes elastic, rubber, or another flexible or resilient material, is attached to the rear portion of material 18 just beneath loop 22. Band 24 may also be attached to base 16 or material 18 at other locations and by any acceptable attachment means. When band 24 is deployed as shown in FIG. 3, it stretches up and around the front portion of lid 14 and rests against ridge 15. Band 24 pulls lid 14 and body 12 downward against base 16 so that the stapler is held in an essentially “closed” position. Although body 12 is not shown contacting base 16 in FIG. 3, it should be understood that when band 24 is fully deployed, these two components of stapler 10 are either in contact with one another or in relatively close proximity to one another. Band 24 may be released by simply stretching it away from ridge 15 and returning it to its neutral position, as shown in FIGS. 1 and 2.

A method for securing the stapler of the present invention in a closed position includes: closing the body and lid of the described stapler and deploying band 24 over the front portion of lid 14. Deploying band 24 in this manner exerts compressive force on lid 14 sufficient to hold lid 14 and body 12 near or against base 16, thereby reducing the overall size, i.e., profile, of the stapler and facilitating transport of the stapler. Miniaturization of some or all of the plastic and metal components of stapler 10 further enhances its portability.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A device for dispensing staples, comprising:
(a) a top portion;
(b) a bottom portion connected to the top portion; and
(c) a flexible band attached to or formed integrally with the bottom portion, wherein deploying the flexible band over the top portion secures the top portion to the bottom portion.

2. The device of claim 1, wherein the bottom portion further includes a loop of material attached to or formed integrally therewith, and wherein the loop of material may be used to hang the device from or attach the device to a key ring or the like.

3. The device of claim 1, wherein at least an area of the bottom portion includes a non-slip material, and wherein the non-slip material reduces slippage of the device across a smooth surface when the device is placed thereon.

4. The device of claim 1, wherein the flexible band is at least partially elastic.

5. A hand-held stapler, comprising:
(a) a body for holding staples and providing a stapling mechanism;
(b) a lid attached to the body by hinge means; and
(c) a base attached to the body and to the lid, wherein the base further includes a first portion and a second portion detachably or fixedly attached to the first portion, wherein the second portion further includes a flexible band attached thereto or formed integrally therewith, and wherein deploying the flexible band over a portion of the lid secures the lid and the body to the base.

6. The stapler of claim 5, wherein the body further comprises a top section, a middle section, and a bottom section, wherein the top section is fixedly attached to the lid, wherein the middle section is hingeably attached to the bottom section and the base, and wherein the bottom section is fixedly attached to the base.

7. The stapler of claim 5, where in the lid further comprises a depression for receiving the thumb of a user of the stapler.

8. The stapler of claim 5, wherein the second portion of the base further comprises a non-slip material for reducing slippage of the stapler when placed on a smooth surface.

9. The stapler of claim 5, wherein the second portion of the base further includes a loop of material attached to or formed integrally therewith, and wherein the loop of material may be used to hang the device from or attach the device to a key ring or the like.

10. The stapler of claim 5, wherein the second portion of the base further comprises elastomer, rubber, rubberized plastic, or combinations thereof.

11. The stapler of claim 5, wherein the flexible band is at least partially elastic.

12. The stapler of claim 5, wherein the body is metal, the lid is plastic, and the base is at least partially plastic.

13. The stapler of claim 5, wherein the overall size of the stapler has been reduced to create a miniature stapler for easy storage and transport in pockets, purses, book bags, and the like.

14. A method for securing a stapler in a closed position, comprising:
(a) providing a stapler, wherein the stapler further includes:
(i) a body for holding staples and providing a stapling mechanism;
(ii) a lid attached to the body by hinge means;
(iii) a base attached to the body and to the lid, wherein the base further includes a first portion and a second portion, and wherein the second portion further includes a flexible band attached thereto or formed integrally therewith; and
(b) deploying the flexible band over a front portion of the lid when the stapler is in the closed position, wherein deploying the flexible band exerts compressive force on the lid sufficient to hold the lid and the body near the base or against the base.

15. The method of claim 14, wherein the second portion of the base further comprises a non-slip material for reducing slippage of the stapler when placed on a smooth surface.

16. The method of claim 14, wherein the second portion of the base further includes a loop of material attached to or formed integrally therewith, and wherein the loop of material may be used to hang the device from or attach the device to a key ring or the like.

17. The method of claim 14, wherein the second portion of the base further comprises at least one of elastomer, rubber and rubberized plastic.

18. The method of claim 14, wherein the flexible band is at least partially elastic.

19. The method of claim 14, wherein the body is metal, the lid is plastic, and the base is at least partially plastic.

20. The method of claim 14, wherein the overall size of the stapler has been reduced to create a miniature stapler for easy storage and transport in pockets, purses, book bags, and the like.
